(19) United States
(12) Patent Application Publication
(10) Pub. No.: US 2019/0240601 A1
(43) Pub. Date: Aug. 8, 2019

(54) FILTER BAG DETECTION

(71) Applicant: Hilti Aktiengesellschaft, Schaan (LI)

(72) Inventor: Hans RUPPRECHT, Muenchen (DE)

(21) Appl. No.: 16/344,090

(22) PCT Filed: Oct. 31, 2017
(86) PCT No.: PCT/EP2017/077855

§ 371 Date: Apr. 23, 2019

(30) Foreign Application Priority Data
Nov. 7, 2016 (EP) 16197473.8

(51) Int. Cl. B01D 35/143; B23Q 11/10

(52) U.S. Cl. CPC B01D 35/143; A47L 9/1472; B23Q 11/1069

(57) ABSTRACT

A device (A) to detect a filtering means (14) in a water treatment unit (1) including at least one signal transmitter (13) and at least one sensor (12) to detect a signal from the signal transmitter (13), whereby the water treatment unit (1) can be set at least in a work mode or in a sleep mode. The water treatment unit (1) is configured in such a way that the work mode can only be set if at least one signal which is emitted by the signal transmitter (13) is detected by the sensor (12). A filter (14) and a suction head (3) for use in the device (A). A system including a filter (14) and a suction head (3) for use in the device (A).

The present invention relates to a device to detect a filtering means in a water treatment unit comprising at least one signal transmitter and at least one sensor to detect a signal from the signal transmitter, whereby the water treatment unit can be set at least in a work mode or in a sleep mode. Instead of the water treatment unit, it is also possible to employ a vacuum cleaner.

The invention also relates to a filtering means as well as to a suction head for use in the device according to the invention. Moreover, the invention relates to a system comprising a filtering means as well as a suction head for use in the device according to the invention.

### BACKGROUND

Water treatment units constitute a water recycling system in which water circulates in a closed circuit with a core drilling machine or a circular saw. According to an alternative mode of operation of the water treatment unit, however, it is also possible that there is no water circulating in a circuit with the power tools, but rather, the water is only conveyed to the power tools by means of the water treatment unit. When core drilling machines or circular saws are being used to cut a mineral material, for instance, concrete or rock, it is necessary to cool and rinse the tool, that is to say, the drill bit or the saw blade. Rinsing the tool serves to wash off dust and mud formed during the working of the material. Normally, the tool of a core drilling machine or circular saw is cooled and rinsed with water. For this purpose, the water is provided by a water treatment unit. The water is stored in a reservoir of the water treatment unit. A water pump that is located in a so-called suction head of the water treatment unit and that is usually positioned above the water tank conveys the water to the tools via a water line (water hose). The water circulates so that it is returned in a second water line (water hose) to the water treatment unit after the tools (drill bit or saw blade) have been cooled and rinsed. The cooling and rinsing of the tools, however, soils the water with dust and mud that has been formed during the working of the material. In order to prevent the components and especially the pump of the water treatment unit from being damaged by the dust or mud, the dirty water has to be filtered. For this purpose, there is a filtering means in the water treatment unit. Normally, the filtering means is configured in the form of a filter bag through which the water is filtered before it is returned to the water tank and can once again be conveyed to the tools by the pump of the suction head.

In order to prevent damage to the water treatment unit or to individual components of the water treatment unit, especially the pump, it is not permissible for dirty water to be conveyed by the pump.

When it comes to the commercially available water treatment units or the water treatment units according to the state of the art, however, it is very well possible for dirty water to get into the pump, thereby damaging it.

### SUMMARY OF THE INVENTION

It is an object of the present invention to provide a device that can reduce the chance of damage to the water treatment unit and especially to the pump of the water treatment unit. Moreover, the objective consists of putting forward a filtering means, a suction head and a system comprising a filtering means as well as a suction head for use in the device according to the invention.

In this context, the present invention provides a device to detect a filtering means in a water treatment unit comprising at least one signal transmitter and at least one sensor to detect a signal from the signal transmitter, whereby the water treatment unit can be set at least in a work mode or in a sleep mode.

According to the invention, it is provided for the water treatment unit to be configured in such a way the work mode can only be set if at least one signal which is emitted by the signal transmitter is detected by the sensor. In this manner, it can be ensured that the water treatment unit can only be operated in the work mode during which the pump of the suction head pumps water, if a filtering means is correctly positioned in the water treatment unit, so that only filtered water enters the pump and the likelihood of damage to the pump is minimized. Moreover, this provides the user of the water treatment unit with a simple and effective orientation aid to correctly position the filtering means inside the water treatment unit. Since the water treatment unit does not change from the sleep mode in the work mode, the user can see that the water treatment unit contains either an incorrect, that is to say, unsuitable, filtering means or else a correct filtering means that is not properly positioned and thus the user has to remedy this before the water treatment unit can be used.

According to an advantageous embodiment of the present invention, it can be possible for the signal transmitter to be positioned on a flange part of the filtering means and for the sensor to be positioned on a suction head of the water treatment unit, so that at least one signal which is emitted by the signal transmitter can be detected by the sensor. As a result, it is possible to ensure a precise positioning and thus the correct arrangement of the filtering means relative to the suction head in which the pump that is to be protected is located.

According to another advantageous embodiment of the present invention, it can be provided for the signal transmitter to be configured in the form of at least one magnet and for the sensor to be configured in the form of at least one magnetic field sensor, especially a Hall sensor. In this manner, a relatively inexpensive and, at the same time, reliable signal transmitter and sensor can easily be made available. The magnet can be configured in the form of a permanent magnet.

According to an advantageous embodiment of the present invention, it can be possible for the signal transmitter to have a circular cross sectional surface and for the flange part to have a cutout with a circular cross sectional surface to receive a filling nozzle of the suction head, whereby the signal transmitter is positioned on the flange part in such a way that the mid-point of the cross sectional surface of the signal transmitter is at a distance of 10 mm to 20 mm, especially 16 mm, in a direction B as well as at a distance of 40 mm to 60 mm, especially 50 mm, in a direction E from the mid-point of the cross sectional surface of the cutout. This makes it possible to ensure a highly precise positioning or arrangement of the cutout of the filtering means relative to the filling nozzle of the suction head. The exact positioning or arrangement ensures a secure fit and correct filling of the filtering means, without dirty water flowing past the filtering means and ending up in the water tank containing filtered water.

Additional advantages ensue from the description of the figures below. The figures depict several embodiments of the present invention. The figures, the description and the claims contain numerous features in combination. The person skilled in the art will advantageously also consider the features individually and merge them to form additional meaningful combinations.

### BRIEF DESCRIPTION OF THE DRAWINGS

Identical and similar components are provided with the same reference numerals in the figures. The following is shown:

FIG. 1: a perspective view of a water treatment unit having a suction head and a water tank, in a disassembled state;

FIG. 2: a perspective view of the suction head of the water treatment unit;

FIG. 3: a perspective view of the water tank of the water treatment unit, in a first orientation;

FIG. 4: a perspective view of the water tank of the water treatment unit, in a second orientation;

FIG. 5: a filtering means in the form of a filter bag together with a flange part and a flange holder;

FIG. 6: a perspective view of the water tank together with a flange part of the filtering means;

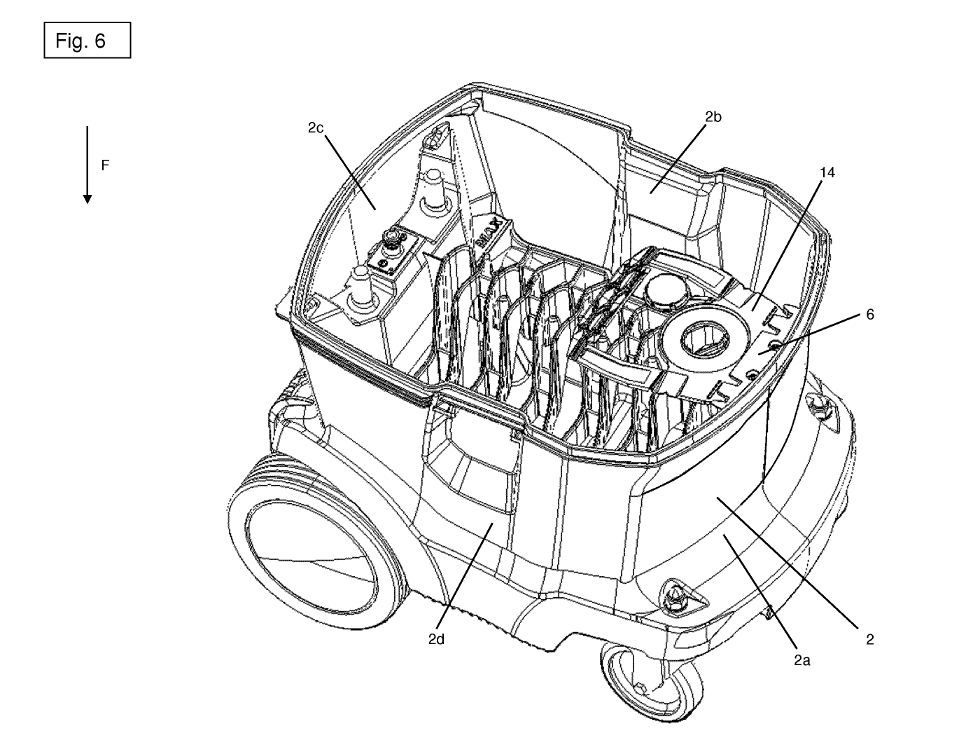

FIG. 7: a second perspective view of the water tank together with a flange part of the filtering means;

FIG. 8: a first bottom view of a part of the suction head;

FIG. 9: a second bottom view of a part of the suction head together with the flange part of the filtering means;

FIG. 10: an overall bottom view of the suction head together with the flange part of the filtering means;

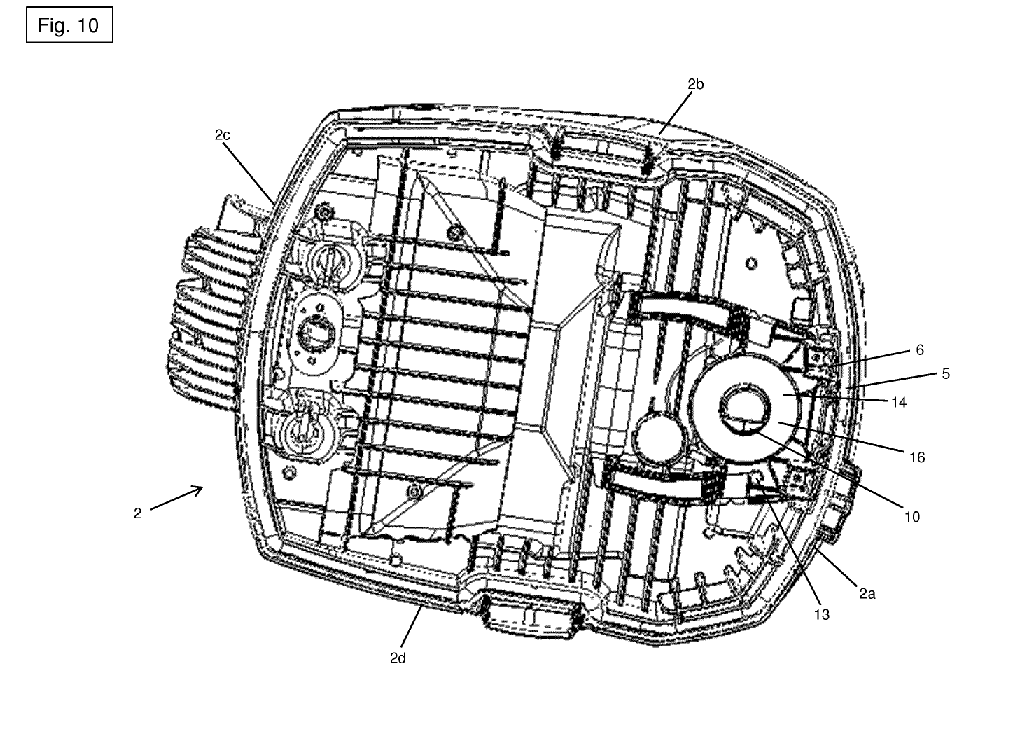

FIG. 11: a top view of the flange part of the filtering means;

FIG. 12: a bottom view of the flange part of the filtering means;

FIG. 13: a perspective view of the top of the flange part of the filtering means together with a flange holder;

FIG. 14: a perspective view of the bottom of the flange part of the filtering means together with the flange holder;

FIG. 15: a perspective view of the flange holder; and

FIG. 16: a detailed view of the flange holder with the flange part.

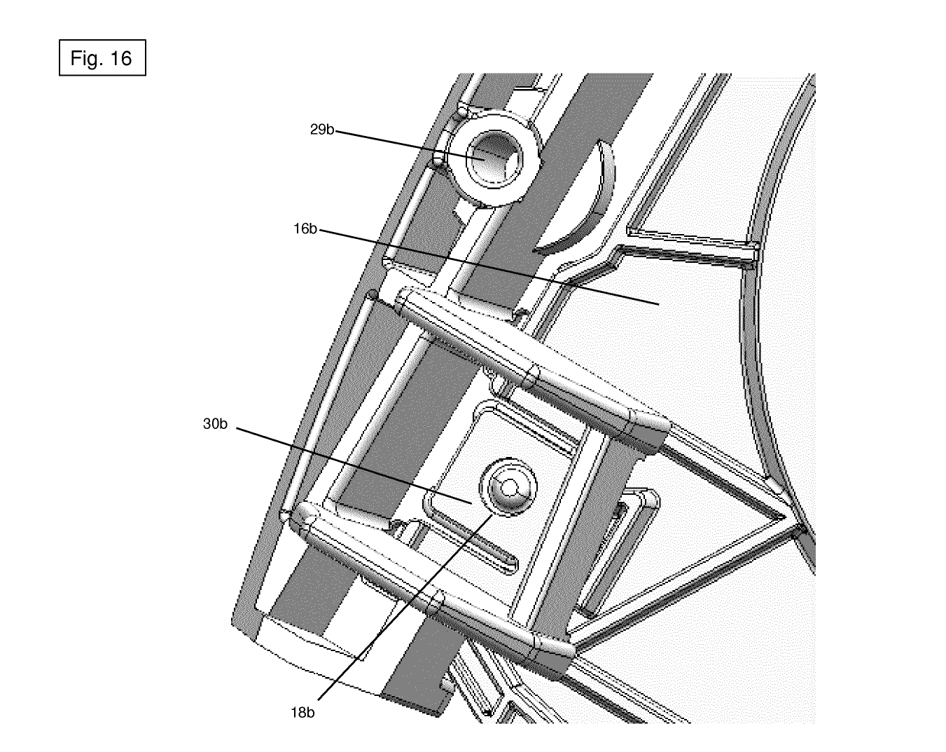

### DETAILED DESCRIPTION

### Embodiments

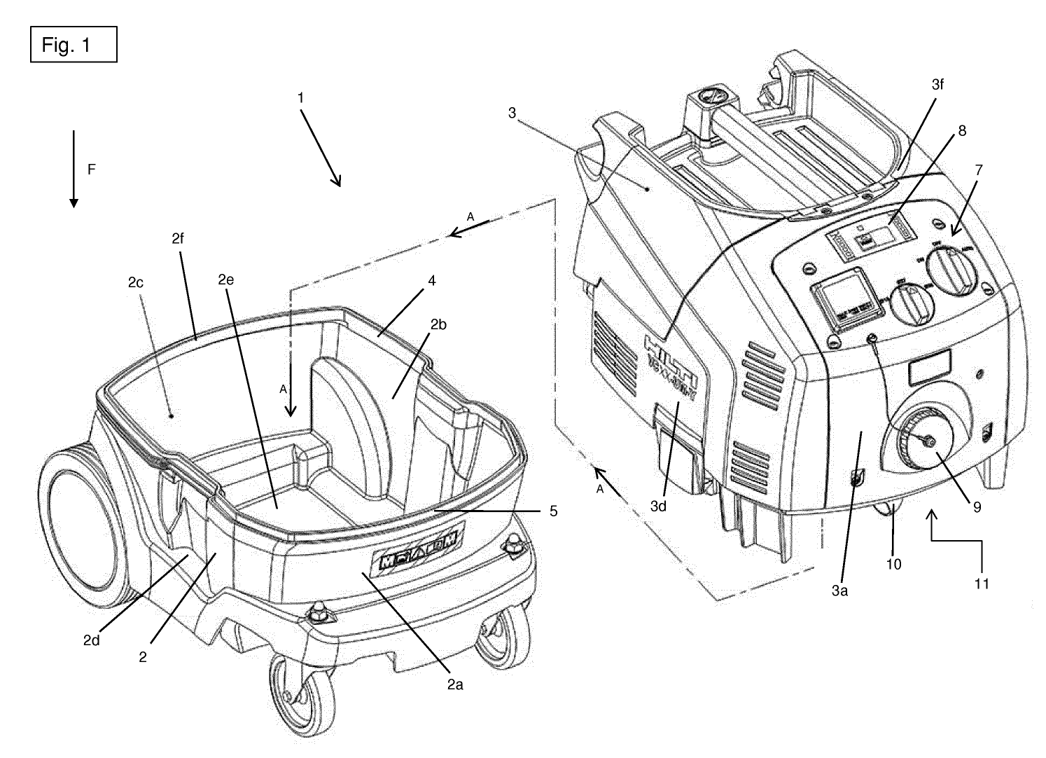

FIG. 1 shows a water treatment unit 1 in a dismantled or disassembled state. The water treatment unit 1 essentially comprises a device A to detect a filtering means 14, a water tank 2 and a suction head 3. The suction head 3 can also be referred to as the device head.

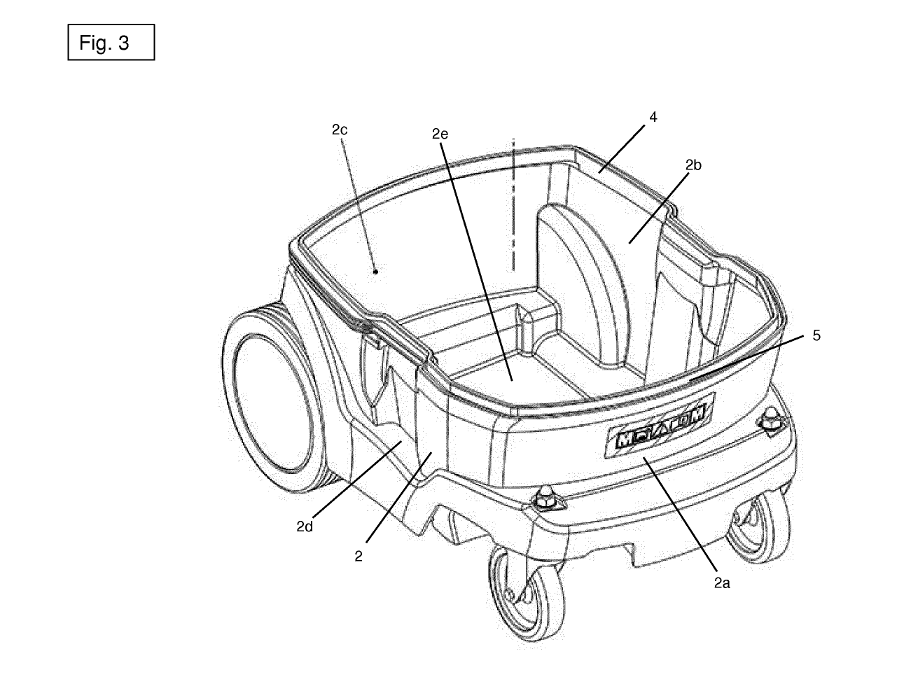

As shown in FIGS. 1, 3 and 4, the water tank 2 is essentially configured in the form of a tub and serves to store or hold water. The water tank 2 has first, second, third and fourth side walls 2a, 2b, 2c, 2d as well as a bottom 2e. Moreover, the water tank 2 has an encircling rim 4. A mounting fixture 5 for a flange holder 6 is positioned on the inside of the first side wall 2a. The mounting fixture 5 as well as the flange holder 6 are described in detail below.

Four wheels are provided on the bottom 2e of the water tank 2 and they can be used to move the water tank or—when in the assembled state—the entire water treatment unit 1.

In the assembled state, the suction head 3 is positioned on the water tank 2 and it can be detachably joined to the water tank 2.

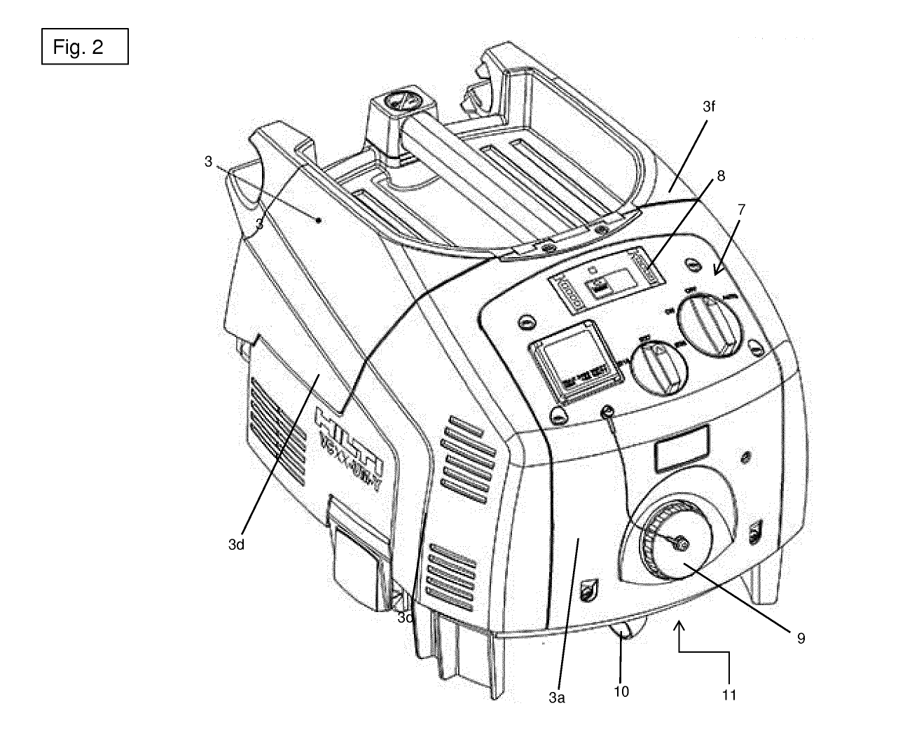

As shown in FIGS. 1 and 2, the suction head 3 has first, second, third and fourth side walls 3a, 3b, 3c, 3d as well as a bottom 3e and a cover 3f. Moreover, the suction head 3 has a pump with which water can be pumped. However, it is also possible for the water treatment unit 1 to have more than one pump. The pump is not shown in the figures. Various operating elements 7, a display 8 as well as a water connector 9 for the dirty water coming from the power tools are provided on the first side wall 3a. The water connector 9 leads to a line that ultimately opens up into a filling nozzle 10 at the bottom 11 of the suction head 3 (see FIG. 2).

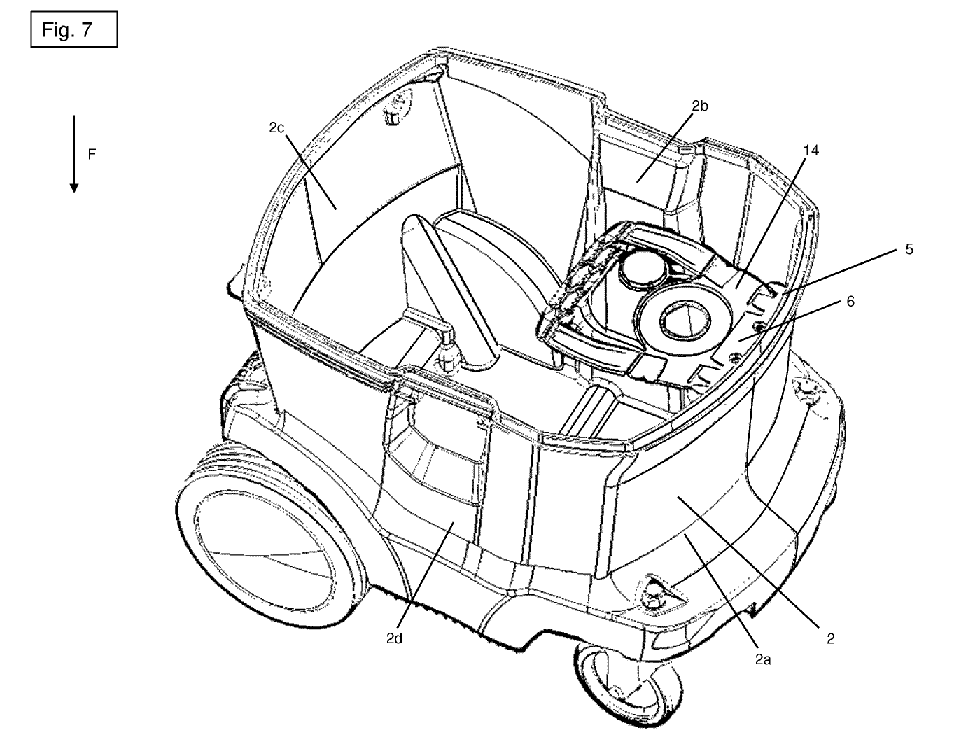

As is shown in FIGS. 7, 8 and 9, the filling nozzle 10 is configured in the form of a cylindrical pipe. Moreover, a sensor 12 in the form of a magnetic field sensor is positioned at the bottom 11 of the suction head 3. In the embodiment shown, the sensor 12 is a Hall sensor. The sensor 12 serves to detect a signal coming from a magnet 13, that is to say, a magnetic field generated by the magnet 13, and it is positioned next to the filling nozzle 10 (not shown here) in the arrow direction E. The sensor 12 is connected to a control unit (not shown here) located in the suction head 3. When the sensor 12 detects or receives the signal (that is to say, the magnetic field) coming from the magnet 13, the sensor 12 sends the detected signal to the control unit. In response to received signal, the control unit switches the water treatment unit 1 into a work mode or into a sleep mode. In the work mode, water is conveyed by the pump out of the water tank 2 to the power tools that are connected to the water treatment unit 1. Subsequently, the water is returned from the power tools by means of the pump and it is filtered in a filtering means 14.

The filtered water then reaches the water tank 2 once again, so that the filtered water can be conveyed to the power tools once again. The water circulates between the power tools and the water treatment unit 1. In the sleep mode, no water is conveyed by the pump. The work mode as well as the sleep mode are indicated either visually and/or acoustically on the display 8. However, it is also possible for the water treatment unit 1 to have additional modes aside from the work mode and the sleep mode.

Thus, for instance, it is possible for the water treatment unit 1 to have a mode with which only water from the water tank 2 is conveyed to the power tools but it is not subsequently returned to the water treatment unit 1. In this mode, there is no need for a filtering means 14 in the water treatment unit 1.

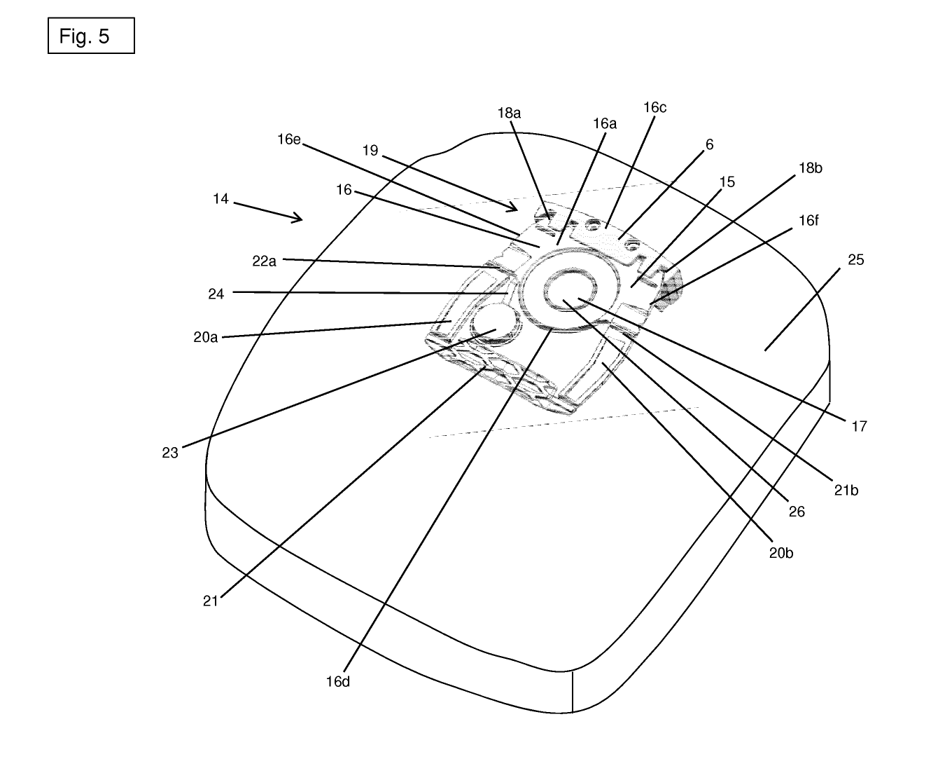

The filtering means 14 can be positioned inside the water tank 2. As shown in FIG. 5, the filtering means 14 essentially has a flange part 15 and a filter bag 25. The filter bag 25 can also be referred to as a filter sack. As already described above, the filtering means 14 serves to filter the water that is returned to the water treatment unit 1 from the power tools or the tools, for example, the drill bit or saw blade.

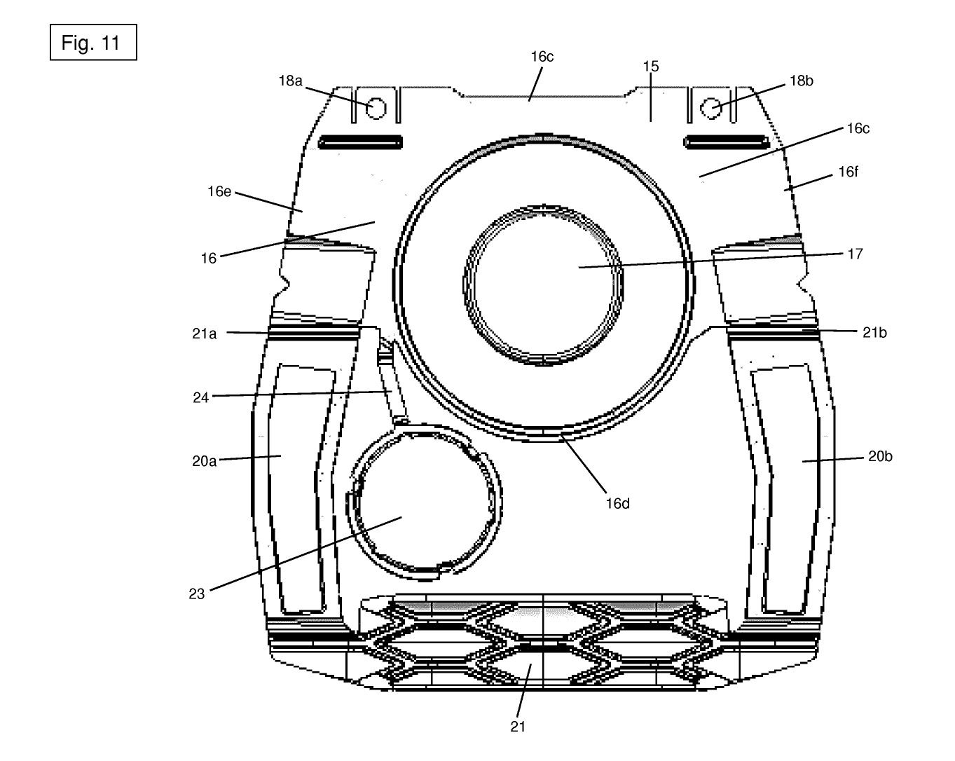

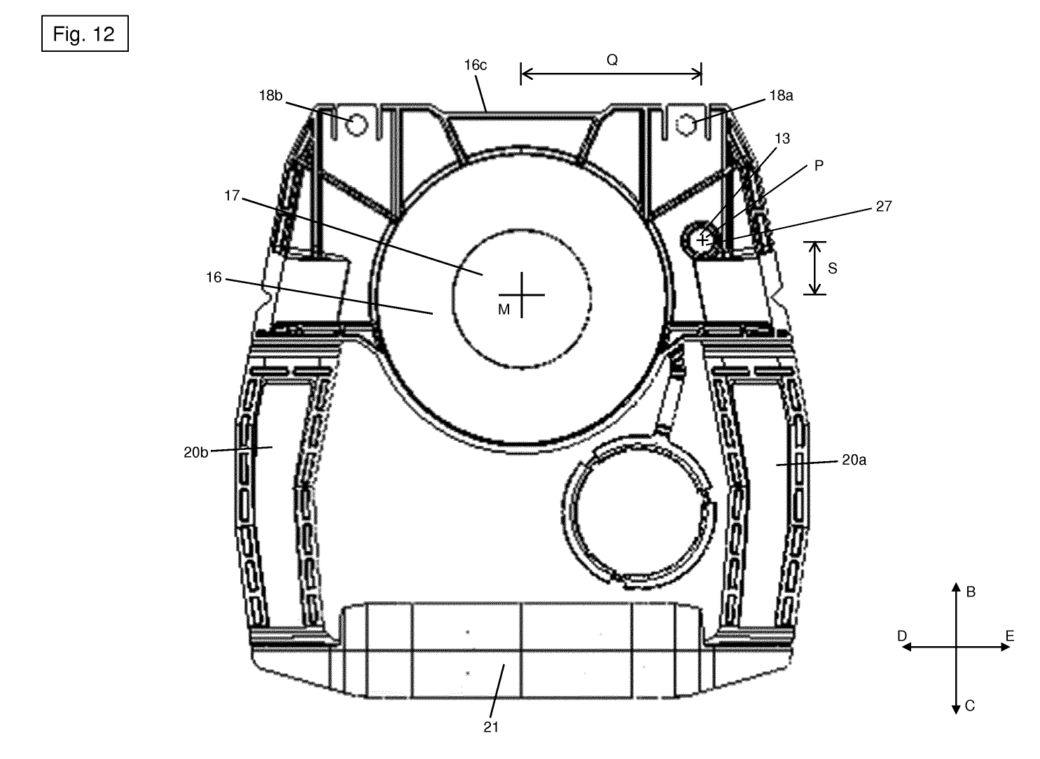

As shown in FIGS. 11 and 12, the flange part 15 essentially comprises a baseplate 16 having a top 16a, a bottom 16b, a front 16c, a rear 16d, a first side 16e and a second side 16f. In the middle of the baseplate 16, there is central, circular cutout 17. The cutout 17 can also be referred to as hole. The cutout 17 serves to receive the filling nozzle 10 of the suction head 3 so that the dirty water coming from the power tools can enter the filtering means 14 via the filling nozzle 10 and through the cutout 17. A first connecting element 18a and a second connecting element 18b are provided on both outer ends of the front 16c. The first as well as the second connecting elements 18a, 18b are integral parts of a connection system 19 with which the flange part 15 of the filtering means 14 can be detachably connected to the flange holder 6 of the water tank 2. The connection system 19 can be essentially configured in the form of a snap-fit connector.

A first arm element 20a and a second arm element 20b are provided on the outer ends of the rear 16b of the baseplate 16. The free ends of the first and second arm elements 20a, 20b are connected to each other by means of a handle 21. The handle 21 serves to carry the filtering means 14.

The first as well as the second arms element 20a, 20b are each movably connected to the baseplate 16 by means of a first hinge 22a and a second hinge 22b so that the first arm element 20a, the second arm element 20b and the handle 21 can reversibly pivot around the rotational axis N in the direction of the arrow R. In the present embodiment, the first and second hinges 22a, 22b are configured as film hinges.

Moreover, a closure cap 23 that optionally closes the cutout 17 is attached to the rear 16d of the baseplate 16 by means of a flexible connecting strip 24. The closure cap 23 especially serves to close off the filtering means 1 when it is full.

The filter bag 25 is made of flexible material through which water, but not dirt particles, can pass. The filter bag 25 has a circular opening 26 and it is attached to the bottom 16b of the baseplate 16 of the flange part 15. The opening 26 serves to receive the filling nozzle 10 of the suction head 3, so that the dirty water can enter the interior of the filter bag 25. The circular opening 26 of the filter bag 25 here is arranged underneath the center, circular cutout 17 of the baseplate 16 so that the opening 26 and the cutout 17 are congruent. In this context, the diameter of the opening 26 of the filter bag 25 is smaller than the diameter of the cutout 17 of the flange part 15. Here, the diameter of the opening 26 corresponds essentially to the diameter of the filling nozzle 10 of the suction head 3. The filter bag material protruding into the cutout 17 serves as a gasket between the filling nozzle 10 and the cutout 17 of the flange part 15 when the filtering means 14 is connected to the suction head 3.

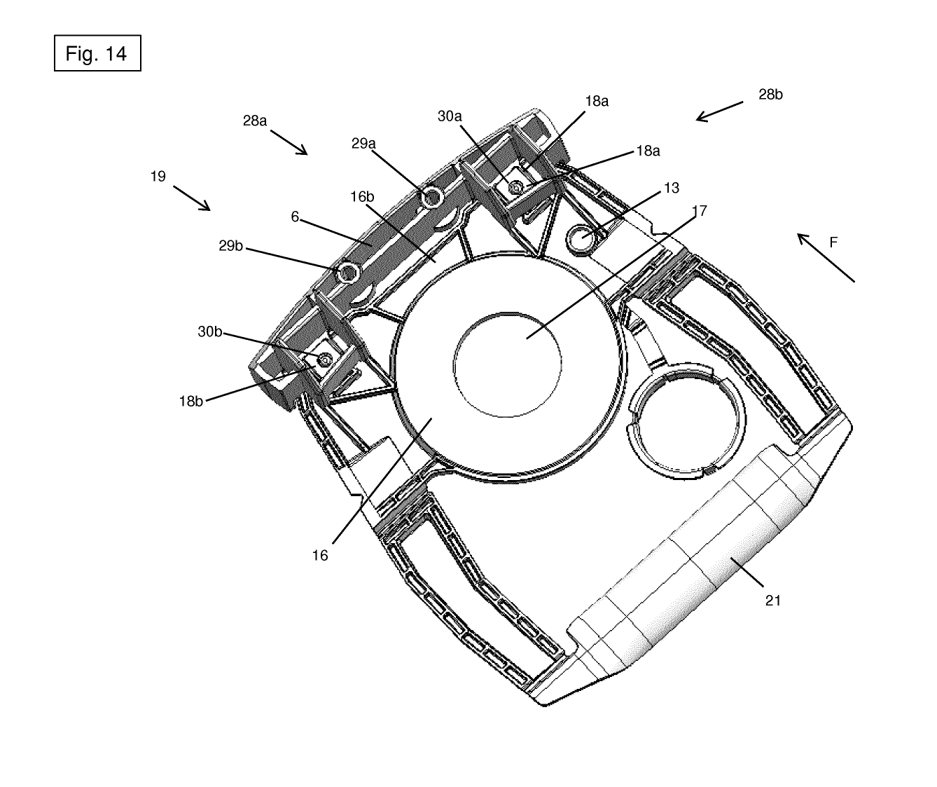

As shown in FIGS. 12 and 14, the bottom 16b of the baseplate 16 of the flange part 15 has a circular receptacle 27 for a signal transmitter. The signal transmitter is configured in the form of the circular magnet 13 and is positioned in the receptacle. The signal transmitter 13 configured as a magnet has a circular cross sectional surface and a mid-point P. The circular cutout 17 of the baseplate 16 likewise has a circular cross sectional surface with a mid-point M. The mid-point P is at a distance of 16 mm in the arrow direction B, that is to say, distance S, and at a distance of 50 mm in the arrow direction D, that is to say, distance Q, relative to the mid-point M. In the assembled state, that is to say, when the filtering means 14 is in the water tank and the suction head 3 is on the water tank 2, the magnet is positioned in the direction of F underneath the sensor 12 of the suction head 3, so that the sensor 12 can detect the magnet or signals coming from the magnet 13.

The thickness of the baseplate 16 and the magnetic force of the magnet 13 are selected here in such a way that the magnetic field of the magnet 13 can pass all the way through the baseplate 16 and can reach the sensor 12 with sufficient strength.

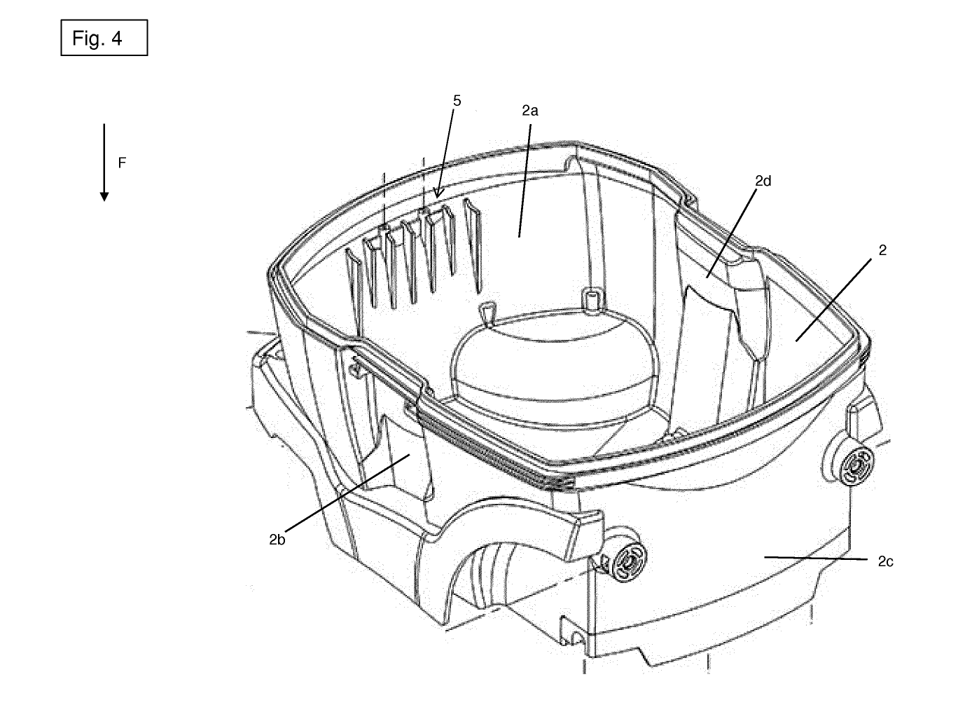

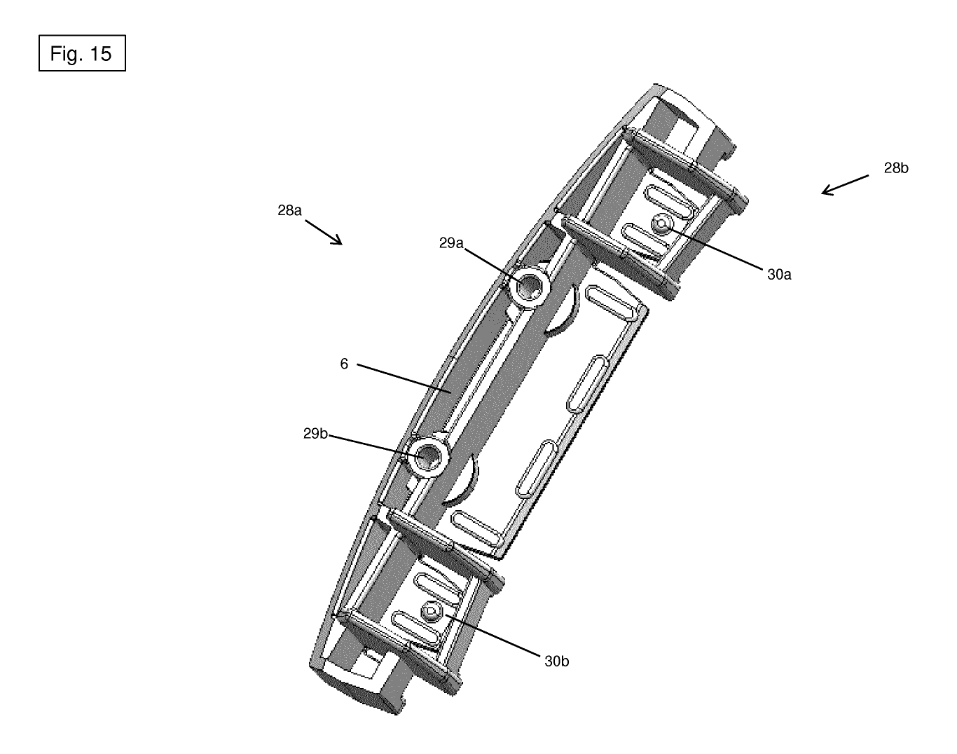

As shown in FIG. 15, the flange holder 6 consists of a first holder 28a and a second holder 28b. The first holder 28a has two mounting elements 29a, 29b and it serves for attachment purposes to the mounting fixture 5 (see FIG. 4). The two mounting elements 29a, 29b are inserted into two appertaining pins of the mounting fixture 5 in the arrow direction F. The second holder 28b has two mounting elements 30a, 30b into which the first and second connecting elements 18a, 18b can be positioned. The two mounting elements 29a, 29b are likewise integral parts of the above-mentioned connection system 19 with which the flange part 15 of the filtering means 14 can be detachably connected to the flange part 6 of the water tank 2.

Assembly and mode of operation of the filtering means:

In order to position the filtering means 14 in the water treatment unit 1, first of all, the suction head 3 is removed from the water tank 2 (see FIG. 1).

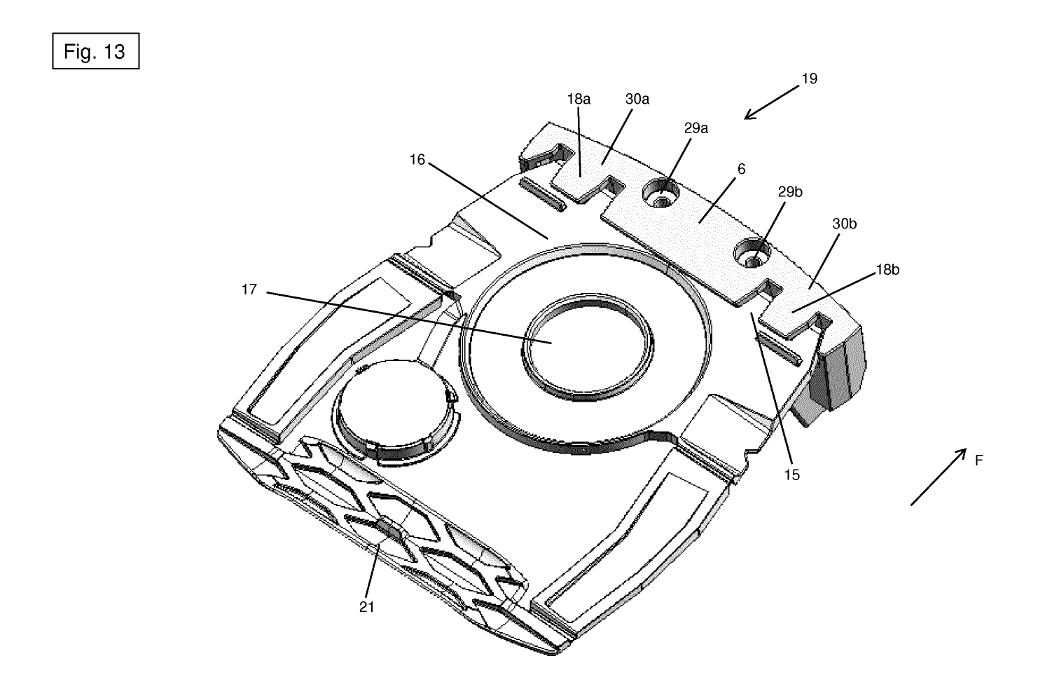

The flange holder 6 is placed onto the mounting fixture 5 in the arrow direction F. The flange part 15 of the filtering means 14 is attached to the flange holder 6. In FIGS. 13 and 14, the flange part 15 is in an assembled state with the flange holder 6. The filtering means 14 is thus in the water tank 2.

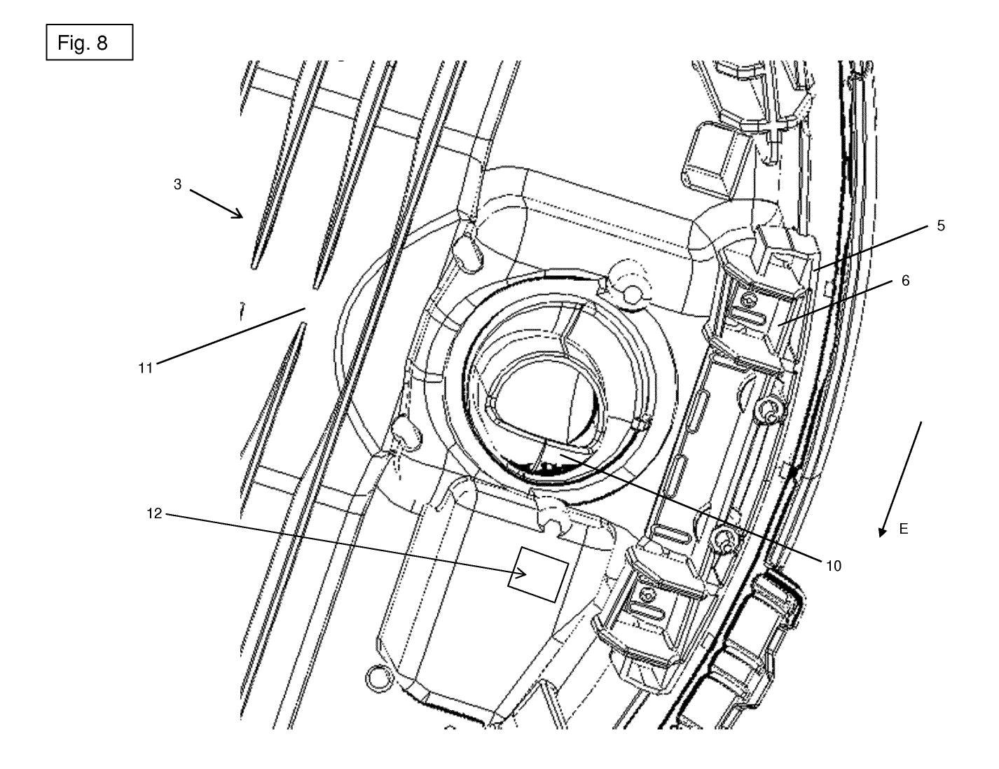

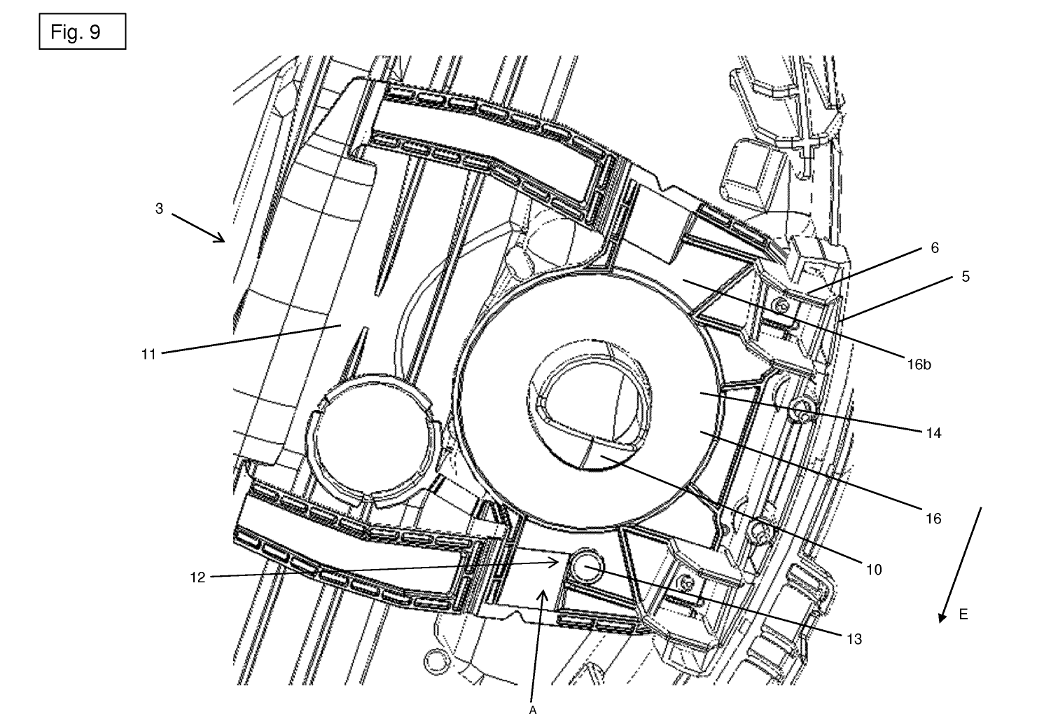

Subsequently, the suction head 3 is once again positioned onto the water tank 2 and secured in place. In the assembled state of the water treatment unit 1, the sensor 12 is positioned in the suction head 3 counter to the arrow direction F above the magnet 13 (see FIGS. 8 and 9) in order to detect the signals coming from the magnet 13, that is to say, the magnetic field. When the magnetic field, that is to say, the signal coming from the magnet is detected by the sensor 12, a corresponding signal is sent to the control unit and the work mode for the water treatment unit 1 is set.

When no signal is detected by the sensor 12, no corresponding signal is sent to the control unit and the sleep mode for the water treatment unit 1 is set.

1-7. (canceled)

8. A device to detect a filtering means in a water treatment unit, the device comprising:
at least one signal transmitter; and
at least one sensor to detect a signal from the signal transmitter, the water treatment unit settable at least in a work mode or in a sleep mode, the water treatment unit configured in such a way that the work mode is only settable if at least one signal emitted by the signal transmitter is detected by the sensor.

9. The device as recited in claim 8 wherein the signal transmitter is positioned on a flange part of the filtering means and the sensor is positioned on a suction head of the water treatment unit, so that the at least one signal emitted by the signal transmitter is detectable by the sensor.

10. The device as recited in claim 9 wherein the signal transmitter is configured in the form of at least one magnet and the sensor is configured in the form of at least one magnetic field sensor.

11. The device as recited in claim 10 wherein the at least one magnetic field sensor is a Hall sensor.

12. The device as recited in claim 9 wherein the signal transmitter has a circular cross sectional surface and the flange part has a cutout with a circular cross sectional surface to receive a filling nozzle of the suction head, the signal transmitter being positioned on the flange part in such a way that a mid-point of the cross sectional surface of the signal transmitter is at a distance of 10 mm to 20 mm in a first direction (B) as well as at a distance of 40 mm to 60 mm in a second direction (E) from the mid-point of the cross sectional surface of the cutout.

13. The device as recited in claim 12 wherein the signal transmitter has a circular the mid-point in the first direction at a distance of 16 mm, and at a distance of 50 mm in the second direction.

14. A method of using the device as recited in claim 8 comprising detecting the filtering means.

15. A method of using the device as recited in claim 8 comprising detecting if the filtering means is on a suction head of the water filtration device.

16. A system comprising the device as recited in claim 8, the filtering means, a suction head of the water treatment unit.

17. A water treatment device comprising:
a filter; and
a detector to detect the filter, the detector including at least one signal transmitter and at least one sensor to detect a signal from the signal transmitter,
the water treatment unit settable at least in a work mode or in a sleep mode, the work mode settable only if at least one signal emitted by the signal transmitter is detected by the sensor.
